(19) United States
(12) Patent Application Publication
(10) Pub. No.: US 2010/0180170 A1
(43) Pub. Date: Jul. 15, 2010

(54) METHOD FOR RETRANSMITTING PACKETS IN MIMO SYSTEM

(75) Inventors: Bang-Won Seo, Daejon (KR); Hee-Soo Lee, Daejon (KR); Hyun-Kyu Chung, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejon (KR)

(21) Appl. No.: 12/438,321

(22) PCT Filed: Aug. 21, 2007
(86) PCT No.: PCT/KR07/03995

§ 371 Date: Nov. 10, 2009

(30) Foreign Application Priority Data
Aug. 22, 2006 (KR) 10-2006-0079545
Nov. 14, 2006 (KR) 10-2006-0112378

(51) Int. Cl. H04L 1/08; G06F 11/14

(52) U.S. Cl. 714/748; 714/E11.131

(57) ABSTRACT

Provided is a method for retransmitting packet in a Multiple Input Multiple Output (MIMO) system. The method includes: in a receiving block, decoding packets received from a transmitting block and detecting whether an error exists or not in the packets; if the error is detected, transmitting a negative acknowledgement (NACK) signal informing transmission failure of the packets to the transmitting block; calculating channel quality information (CQI) values for transmission-failed packets after performing successive interference cancellation (SIC) with respect to all antenna combinations to retransmit the transmission-failed packets; and selecting an antenna combination having CQI values of the transmission-failed packets which are equal to or greater than respective initial CQI values of the transmission-failed packets among the antenna combinations, and transmitting information of the selected antenna combination to the transmitting block.

### TECHNICAL FIELD

The present invention relates to a method for retransmitting packets in a Multiple Input Multiple Output (MIMO) system; and, more particularly, to a method for retransmitting packets when some of received packets failed to be decoded in a MIMO system which transmits and receives a plurality of packets or code words simultaneously, using multiple antennas.

### BACKGROUND ART

Multiple Input Multiple Output (MIMO) technology can improve a transmission rate without increasing bandwidth because it transmits/receives data using a plurality of antennas in a receiving block and a transmitting block.

Also, an Orthogonal Frequency Division Multiplexing (OFDM) is a frequency multiplexing method which transmits data by distributing the data onto a plurality of orthogonal carriers. Since orthogonal conditions are given to carriers, each of which can be detected in the receiving block although transmission bandwidths are partially overlapped.

Therefore, an MIMO-OFDM is a technology combining the MIMO and the OFDM. When each antenna transmits different data, theoretical channel capacity increases in proportion to the number of antennas which is smaller between the number of transmitting antennas and the number of receiving antennas. Since the amount of transmission data increases in proportion to the number of antennas, the data transmission rate per unit time can be improved without additional bandwidth in the MIMO-OFDM technology.

In a MIMO system, an automatic repeat request (ARQ) method is used for error control. In the ARQ method, received data are decoded based on a cyclic redundancy check (CRC) code which is excellent in error detection and when an error occurs, the transmitting block is requested to retransmit data.

The ARQ method specifically includes a stop-and-wait method, a go-back-N method, and a selective repeat method.

According to the stop-and-wait method, the transmitting block transmits one information vector to the receiving block, and then it does not transmit the next information vector any more and waits until the receiving block sends an acknowledgement to the transmitting block. The receiving block examines whether or not the received information vector has an error based on an error detection code. When the error is not detected, the receiving block transmits an acknowledgement (ACK) signal to the transmitting block. When the error is detected, the receiving block transmits a negative acknowledgement (NACK) signal to the transmitting block. When the transmitting block receives the ACK signal, transmits the next information vector to the receiving block. When the transmitting block receives the NACK signal, the information vector is retransmitted. The stop-and-wait method is implemented in a simple system structure, but its efficiency is lower than the other methods because the information is not transmitted continuously and waiting time exists.

In the go-back-N method, the transmitting block transmits information vector continuously without waiting an acknowledgement from the receiving block. The transmitting block transmits one information vector to the receiving block, and transmits N-1 other information vectors to the receiving block during a round trip time. Herein, the round trip time is the time for transmitting one information vector and receiving an acknowledgement for the information vector.

When no error is detected, the receiving block transmits the ACK signal to the transmitting block. When the error is detected, the receiving block transmits the NACK signal to the transmitting block. Also, the receiving block abandons continuous N-1 information vectors after the information vector regardless of the presence of an error. When the transmitting block receives the NACK signal, the transmitted information vector is retransmitted and the N-1 continuous information vectors are retransmitted during the round trip time. The go-back-N method has low system efficiency because a lot of information vectors having no error are not used and retransmitted when the round trip time is long.

According to the selective repeat method, when the transmitting block transmits information vectors continuously and receives the NACK signal from the receiving block, the transmitting block retransmits only the information vector corresponding to the NACK signal. The selective repeat method has higher efficiency than the other methods described above, but its system structure is quite complex to be implemented.

The above ARQ methods can be applied to an MIMO system. However, when retransmission is requested in a general wireless communication system, retransmission is performed after several frames are already transmitted. Thus, the channel is changed. Also, when the retransmission is requested, the same transmission antennas are used to retransmit the remaining packets. Since the conventional retransmission methods are inefficient because channel state for the retransmission of the remaining packets is not considered accurately.

### DISCLOSURE OF INVENTION

### Technical Problem

An embodiment of the present invention is directed to providing a method for retransmitting packets which improves decoding performance of retransmission packets in a Multiple Input Multiple Output (MIMO) system by selecting antennas having better channel state than the other antennas and retransmitting packets failed to be decoded.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for retransmitting packets in a Multiple Input Multiple Output (MIMO) system, the method including: in a receiving block, decoding packets received from a transmitting block and detecting whether an error exists or not in the packets; if the error is detected, transmitting a negative acknowledgement (NACK) signal informing transmission failure of the packets to the transmitting block; calculating channel quality information (CQI) values for transmission-failed packets after performing successive interference cancellation (SIC) with respect to all antenna combinations to retransmit the transmission-failed packets; and selecting an antenna combination having CQI values of the transmission-failed packets which are equal to or greater than respective initial CQI values of the transmission-failed packets among the antenna combinations, and transmitting information of the selected antenna combination to the transmitting block.

In accordance with another aspect of the present invention, there is provided a method for retransmitting packets in an MIMO system using a precoder matrix, the method including: in a receiving block, decoding packets received from a transmitting block and detecting whether an error exists or not in the packets; when the error is detected, transmitting a NACK signal informing transmission failure of the packets to the transmitting block; calculating channel quality information (CQI) values for the transmission-failed packets after performing successive interference cancellation (SIC) to all vector combinations for retransmitting the transmission-failed packets, wherein all of the vector combinations are included in the precoder matrix; and selecting a vector combination having CQI values of the transmission-failed packets which are equal to or greater than respective initial CQI values of the transmission-failed packets among the vector combinations, and transmitting information of the selected vector combination to the transmitting block.

In accordance with another aspect of the present invention, there is provided a method for retransmitting packets in an MIMO system, the method including: if a transmitting block receives a NACK signal informing transmission failure from a receiving block, forming, for each transmission-failed packet, a set by collecting packet numbers of transmission-succeeded packets whose CQI values are equal to or greater than an initial CQI value of said each transmission-failed packet; selecting one packet number from each set, wherein the selected packet numbers are different from each other; and transmitting the transmission-failed packets through antennas corresponding to the selected packet numbers.

In accordance with another aspect of the present invention, there is provided a method for retransmitting packets in an MIMO system, the method including: if a transmitting block receives a NACK signal informing transmission failure of packets from a receiving block, forming, for each transmission-failed packet, a set by collecting packet numbers of transmission-succeeded packets whose CQI values are equal to or greater than a value obtained by subtracting a threshold value from an initial CQI value of said each transmission-failed packet; selecting one packet number from each set, wherein the selected packet numbers are different from each other; and transmitting the transmission-failed packets through antennas corresponding to the selected packet numbers.

### Advantageous Effects

The present invention improves decoding performance of retransmission packets by selecting antennas having better channel state and retransmitting packets failed to decode.

Also, in case of the receiving block performs feedback a decoding procedure periodically, the present invention can improve total system performance by setting the decoding procedure to increase decoding success rate of the retransmission packets.

### BRIEF DESCRIPTION OF THE DRAWINGS

FIG. 1 is a block diagram illustrating a transmitting block of a typical Multiple Input Multiple Output (MIMO) system.

FIG. 2 is a block diagram illustrating a receiving block of the typical MIMO system.

FIG. 3 is a flowchart illustrating transmission of additional feedback information from a receiving block to a transmitting block for packet retransmission in accordance with an embodiment of the present invention.

FIG. 4 is a flowchart illustrating a process in the transmitting block when the additional feedback information for packet retransmission is not received from the receiving block in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter, and thus the invention will be easily carried out by those skilled in the art to which the invention pertains. Also, when it is considered that detailed description on a related art may obscure the points of the present invention unnecessarily in describing the present invention, the description will not be provided herein. Hereinafter, specific embodiments of the present invention will be described with reference to the accompanying drawings.

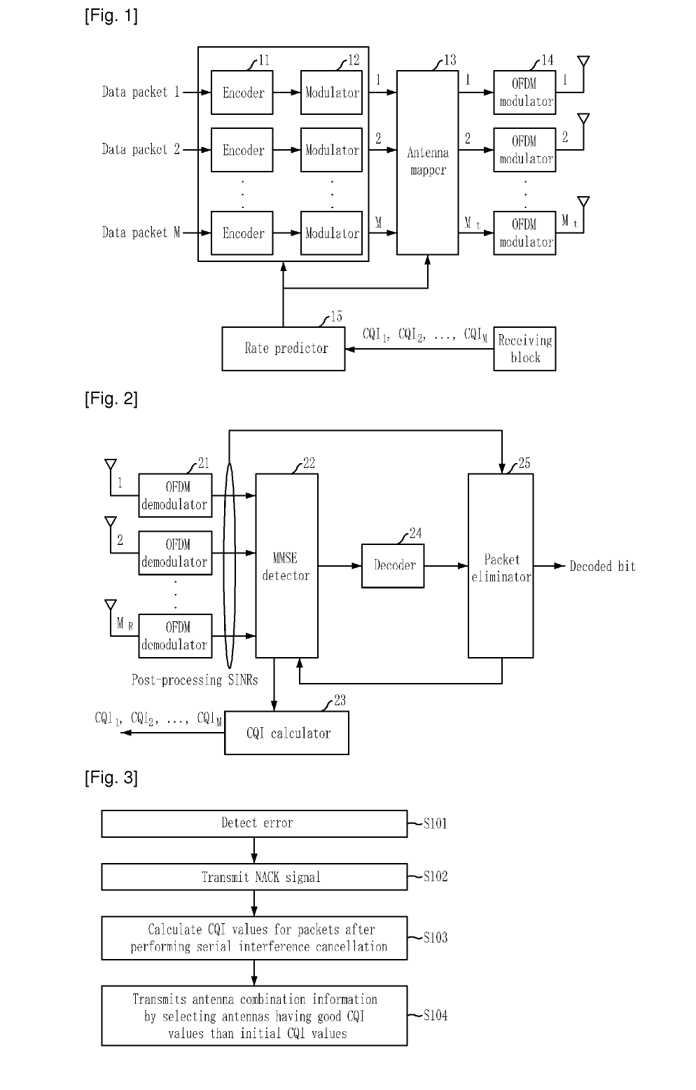

FIG. 1 is a diagram illustrating a transmitting block of a typical Multiple Input Multiple Output (MIMO) system to which the present invention is applied; and FIG. 2 is a diagram illustrating a receiving block of the typical MIMO system.

FIG. 1 shows the transmitting block which transmits M packets simultaneously with Mₜ transmitting antennas. Data packets to be transmitted are encoded in an encoder 11. The number of encoders 11 is the same as the number of the transmitting antennas. Various channel encoders can be used as encoder 11 in order to build a communication system having high reliability. Encoded data outputted from each encoder 11 are inputted into a modulator 12. The modulator 12 modulates the encoded data based on a predetermined modulation method and outputs modulated symbols, or modulated data. An example using a Quadrature Amplitude Modulation (QAM) modulator will be described in the present invention.

An antenna mapper 13 performs mapping QAM data modulated in the QAM modulator 12 into the transmitting antennas. An Orthogonal Frequency Division Multiplexing (OFDM) modulator 14 modulates the QAM modulated data based on an OFDM modulation method, and the OFDM modulated data are outputted through the transmitting antennas. The transmitting block includes a rate predictor 15 which receives channel quality information (CQI) from the receiving block and applies different coding rate and modulation rate according to packets in the MIMO system.

That is, the transmitting block applies a different coding rate and a different modulation rate according to each packet based on the CQI for packets received from the receiving block. Also, the transmitting block performs mapping the QAM modulated data outputted from the QAM modulator 12 into the Mt transmitting antennas based on per antenna rate control (PARC), per stream rate control (PSRC), and virtual antenna signaling method.

FIG. 2 is a diagram illustrating a receiving block of the typical MIMO system using a successive interference cancellation (SIC).

The receiving block includes an OFDM demodulator 21, a minimum mean-squared error (MMSE) detector 22, a CQI calculator 23, a decoder 24 and a packet eliminator 25.

The OFDM demodulator 21 demodulates received RF signals, and the number of the OFDM modulators is the same as the number of receiving antennas. The MMSE detector 22 detects a channel state of the data outputted from the OFDM demodulator 21. The CQI calculator 23 calculates the channel quality information (CQI) of the channel detected in the MMSE detector 22 and feed the CQI back to the transmitting block. The decoder 24 decodes the data detected in the MMSE detector 22. The packet eliminator 25 deletes the packet decoded in the decoder 24 from the total received signal.

The receiving block of the MIMO system will be described in detail. M packets can be decoded based on a procedure predetermined between the transmitting block and the receiving block. Also, a decoding procedure determined in the receiving block based on the channel state may be fed back to the transmitting block periodically.

First, a case of decoding performed based on a predetermined decoding sequence will be described. It is assumed for the sake of convenience that the packets are decoded in a sequence of 1, 2, . . . M.

The receiving block uses the MMSE detector 22 to process a packet 1. The kinds of the detector are various, but the present invention will be described by taking a case using the MMSE detector 22 as an example for the sake of convenience.

Acquisition process of the CQI for each packet fed back from the receiving block to the transmitting block will be described. Average channel quality information CQI₁ of output signals from the MMSE detector with respect to the packet 1 is acquired based on known channel information. Herein, the average value is determined by averaging CQIs for all symbols included in a packet. Generally, a signal-to-interference plus noise ratio (SINR) is used as the value of the CQI. Then, the packet 1 is assumed to be completely deleted from the received signal based on the SIC, and the average CQI₂ value is acquired from the MMSE detector with respect to a packet 2.

The same method described above is used to acquire CQI₃, . . . , CQI_{M}. Then, the receiving block feeds the CQI values back to the transmitting block. The transmitting block adjusts the coding rate and the modulation rate according to each packet and transmits the packets to the receiving block.

Then, a decoding method of the receiving block will be described in detail. The receiving block uses the MMSE detector to process the packet 1, and decoding is performed based on MMSE result values of all symbols included in the packet 1. The MMSE detector is used for the packet 1 among packets 1, 2, . . . , M. When, a cyclic redundancy check (CRC) value of the decoded packet 1 in the decoder 24 is checked and errors do not exist, the packet 1 is decoded without a problem. Then, the packet eliminator 25 generates a received signal with respect to the packet 1 based on the decoded packet 1, and acquires a modified received signal by subtracting the received signal for the packet 1 from the original received signal. When the packet 1 is decoded properly, there is no interference signal for the packet 1 in the modified received signal.

Then, the modified received signal is inputted to the MMSE detector, and the MMSE detector is used to process the packet 2. The MMSE detector is used for packet 2 among the packets 2, 3, . . . , M. The decoder 24 performs the decoding based on MMSE result values of all symbols included in the packet 2. When, the CRC value of the decoded data by the decoder 24 is checked and errors do not exist, the packet 2 is decoded well. Then, the packet eliminator 25 generates a received signal for the packet 2 based on the decoded symbols of the packet 2, and acquires a second modified received signal by subtracting the received signal for the packet 2 from the modified received signal.

The packets 3, 4, . . . , M are decoded based on the second modified received signal in the same procedure described above.

Described herein is a case where N packets among the M packets are decoded properly, and a decoding error occurs in a (N+1)th packet. The receiving block generates a NACK signal for the packet (N+1) and transmits the NACK signal to the transmitting block. Then, the transmitting block retransmits (M-N) packets which are not decoded.

The present invention suggests a method for retransmitting (M-N) packets following a packet having error, when packets transmitted through the Mₜ transmitting antennas turn out to have an error after decoding.

First, a case where the receiving block provides additional feedback information for retransmission will be described.

FIG. 3 is a flowchart illustrating a transmission of the additional feedback information from the receiving block to the transmitting block for packet retransmission in accordance with the present invention.

The error of (N+1)^{th} packet is detected based on a CRC result of decoded data in the receiving block at step S101, the receiving block transmits the NACK signal informing the transmitting block at step S102 of reception failure.

Then, the receiving block calculates the CQI values of packets after performing the SIC onto transmission-failed (M-N) packets, with respect to all cases of selecting antennas for transmitting the transmission-failed (M-N) packets based on Mₜ transmitting antennas in consideration of a sequence at step S 103. The CQI values for each packet with respect to a q^{th} combination of the antennas considering the sequence are assumed as

CQI_{N+1}^{(q)}, COI_{N-2}^{(q)}, . . . , CQI_{M}^{(q)}

. Herein,

CQIᵢ^{(q)}

is the CQI value of a packet i when only the packets i, i+1, M exist among the retransmission packets (N+1), (N+2), . . . , M based on the q^{th} antenna combination.

The CQI values for each packet after performing the SIC are calculated, and one antenna combination is selected and transmitted to the transmitting block at step S 104. The antenna combination is randomly selected among the antenna combinations satisfying the following Eq. 1. In an other selection method, the antenna combination maximizing a total capacity can be selected. That is, as described in the following Eq. 1, an antenna combination is selected among antenna combinations having the CQI value of a specific packet based on the antenna combination is equal to or greater than an initial CQI value of the specific packet, and the selected antenna combination is transmitted into the transmitting block.

CQIᵢ^{(q)}≧CQIᵢ for all i ∈ {N+1, N+2, . . . , M} Eq. 1

The receiving block may feeds the selected antenna combination information back to the transmitting block, but the receiving block may feeds the selected antenna combination information as well as a CQI corresponding to a new antenna combination. When the receiving block transmits the selected antenna combination information, the transmitting block retransmits packets based on the same coding rate and the same modulation rate which are used for the initial transmission. Also, when the receiving block transmits the selected antenna combination information and the new CQI, the transmitting block can adjust the coding rate and the modulation rate based on the new CQI.

In case of a system using precoder before antenna mapping of the packets to be transmitted, (M-N) antennas among M antennas are not selected in consideration of a sequence, but (M-N) vectors are selected among precoder vectors.

In this case,

CQI_{N+1}^{(q)}, CQI_{N+2}^{(q)}, . . . , CQI_{M}^{(q)}

are the CQI values for each packet with respect to the q^{th} combination of the (M-N) vectors combinations considering the sequence in a precoder matrix.

In other words, the receiving block calculates the CQI values of packets after performing the SIC onto transmission-failed (M-N) packets, with respect to all cases of selecting vectors for transmitting the transmission-failed (M-N) packets among the vector forming the precoder at step S103.

As described above, the CQI values for each packet after performing the SIC are calculated, and the vector combination is selected and transmitted to the transmitting block at step S104. That is, the vector combination is selected one of vector combinations having the CQI value of a specific packet based on the vector combination is equal to or greater than an initial CQI value of the specific packet, and the selected vector combination is transmitted to the transmitting block. In other selection method, the vector combination maximizing the total capacity can be selected.

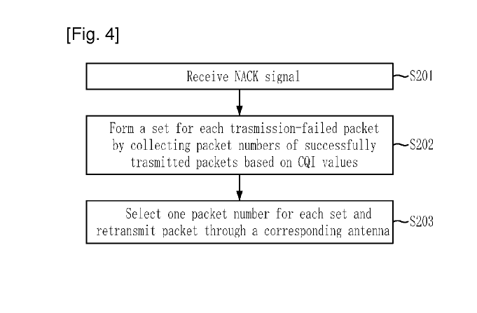

Hereinafter, a case that the receiving block does not provide the additional feedback information of the antenna combination will be described. That is, an antenna selection process for retransmitting when the receiving block fails to decode the packet (N+1) and feeds the NACK signal of the packet (N+1) back to the transmitting block will be described with reference to FIG. 4.

When the transmitting block receives the NACK signal informing presence of an error in the decoded packet from the receiving block at step S201, the transmitting block forms a set by collecting the number of packets that are successfully transmitted according to CQI values with respect to each packet failed to be transmitted at step S202.

In the following Eq. 2, i denotes packets whose transmission is failed and they have a packet number between (N+1) and M; and j denotes packets whose transmission is succeed and they have a packet number between 1 and N. The CQI value of a successfully transmitted packet j and the initial CQI value of a packet whose transmission is failed i are compared. Then, packet numbers (1 to j) of the successfully transmission packets having CQI values equal to or grater than the initial CQI value of the transmission-failed packet i and the packet numbers (i) of the transmission-failed packets are bound together to thereby form the set.

CQIⱼ≧CQIᵢ, B₍ᵢ₎=B₍ᵢ₎ ∪ {j} Eq. 2

In other words, a set B_{N+1} is formed by collecting packet numbers having CQI value equal to or grater than CQI_{N+1} among CQI_{1,} CQI₂, . . . , CQI_{N+1} with respect to the transmission-failed packet (N+1). Similarly, a set B_{N+2} is formed by collecting packet numbers having a CQI value equal to or grater than CQI_{N+2} among CQI₁, CQI₂, CQI_{N+2} with respect to the transmission-failed packet (N+2). In the same manner, the sets for transmission-failed packets (N+3), (N+4), M are formed.

A transmitting antenna combination is selected by randomly selecting an element from each set and packet is retransmitted through a corresponding antenna at step S203. Herein, elements of the same packet numbers are not selected from more than two sets. For example, it is assumed that the number of total packets to be transmitted is 10; 6 of them are successfully transmitted; 4 packets are transmission-failed packets; B₇ is {1,2,3,5,7}; and B₈ is {1,2,3,4,8}. When an antenna 2 is selected to transmit a packet 7, the antenna 2 is not selected for the transmission of a packet 8 and an antenna among 1, 3, 4 and 8 has to be selected to transmit the packet 8.

According to an other method for selecting antenna, an antenna combination maximizing the total capacity can be selected when one element is selected from each set. Of course, the same elements are not selected from more than two sets.

The reason that an antenna is selected in the above described method is as follows. CQIⱼ is a CQI value of a packet j when interference packets i+1, . . . , M exist. If, j is smaller than i, and CQIⱼ is equal to or greater than CQIⱼ, the channel state of the transmitting antenna j is better than that of the transmitting antenna i when the same number of interference packets exist.

Adding a predetermined threshold value dᵢ to Eq. 2, the following Eq. 3 can be derived.

CQIⱼ≧CQIᵢ−δᵢ, B₍ᵢ₎=B₍ᵢ₎ ∪ {j} Eq. 3

That is, although CQIⱼ is smaller than CQIᵢ, an antenna combination satisfying that CQIⱼ is equal to or greater than CQIᵢ−dᵢ can be selected with respect to the predetermined threshold value.

Hereinafter, a system having a receiving block feeding a decoding sequence determined back based on the channel state periodically will be described. Also described is a case where the receiving block fails to perform decoding. The receiving block feeds the NACK signal back to the transmitting block without the additional information.

When the retransmission is not considered, total capacity of the system is known uniform regardless of the decoding sequence. However, when the retransmission is considered, the decoding sequence can affects performance of the system. [75] When the receiving block feeds back the decoding sequence to the transmitting block, the receiving block calculates CQI values for packets with respect to the all combination of the decoding sequence. It is assumed that the q^{th} decoding packet number in a random decoding sequence combination v is v(q), and acquired CQI values for the packets are CQIᵥ₍₁₎, CQIᵥ₍₂₎, . . . , CQI_{v(M)}. Then, decoding sequence combination v which has many (i,j) pairs satisfying that i is smaller than j and CQIᵥ₍ᵢ₎ is equal to or greater than CQIᵥ₍ⱼ₎ is searched. Then, the searched decoding sequence combination information is fed back to the transmitting block.

The transmitting block determines the coding rate and the modulation rate for each transmitting antenna based on the information received from the receiving block. Under the transmitting/receiving environment, when the receiving block fails to decode the packet (N+1), the receiving block feeds back the NACK signal of the packet (N+1) only. Then, the transmitting block retransmits the packets by applying the retransmission method having no additional feedback information as described above referring to FIG. 4. Due to the predetermined decoding sequence, situation such as Eq. 2 or Eq. 3 occurs frequently. Therefore, decoding of the retransmission packets can be improved.

The above described method according to the present invention can be embodied as a program and stored in a computer-readable recording medium. The computer-readable recording medium is any data storage device capable of storing data read by a computer system. The computer-readable recording medium includes a read-only memory (ROM), a random-access memory (RAM), a CD-ROM, a floppy disk, a hard disk and a magneto-optical disk.

The present application contains subject matter related to Korean Patent Application Nos. 2006-0079545 and 2006-0112378, filed in the Korean Intellectual Property Office on Aug. 22, 2006, and Nov. 14, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for retransmitting packets in a Multiple Input Multiple Output (MIMO) system, the method comprising:
in a receiving block, decoding packets received from a transmitting block and detecting whether an error exists or not in the packets;
if the error is detected, transmitting a negative acknowledgement (NACK) signal informing transmission failure of the packets to the transmitting block;
calculating channel quality information (CQI) values for transmission-failed packets after performing successive interference cancellation (SIC) with respect to all antenna combinations to retransmit the transmission-failed packets; and
selecting an antenna combination having CQI values of the transmission-failed packets which are equal to or greater than respective initial CQI values of the transmission-failed packets among the antenna combinations, and transmitting information of the selected antenna combination to the transmitting block.

2. The method of claim 1, wherein the receiving block selects an antenna combination maximizing a total capacity.

3. The method of claim 2, wherein the receiving block transmits the information of the selected antenna combination and the CQI values corresponding to the selected antenna combination.

4. The method of claim 3, further comprising:
In the transmitting block, adjusting a coding rate and a modulation rate for the transmission-failed packets to be retransmitted based on the information of selected antenna combination and the CQI values received from the receiving block; and
transmitting the transmission-failed packets to the receiving block.

5. A method for retransmitting packets in an MIMO system using a precoder matrix, the method comprising:
in a receiving block, decoding packets received from a transmitting block and detecting whether an error exists or not in the packets;
when the error is detected, transmitting a NACK signal informing transmission failure of the packets to the transmitting block;
calculating channel quality information (CQI) values for the transmission-failed packets after performing successive interference cancellation (SIC) to all vector combinations for retransmitting the transmission-failed packets, wherein all of the vector combinations are included in the precoder matrix; and
selecting a vector combination having CQI values of the transmission-failed packets which are equal to or greater than respective initial CQI values of the transmission-failed packets among the vector combinations, and transmitting information of the selected vector combination to the transmitting block.

6. The method of claim 5, wherein the receiving block selects a vector combination maximizing a total capacity.

7. The method of claim 6, wherein the receiving block transmits the information of the selected vector combination and the CQI values corresponding to the selected vector combination.

8. The method of claim 7, further comprising:
in the transmitting block, adjusting a coding rate and a modulation rate for the transmission-failed packets to be retransmitted based on the information of the selected vector combination and the CQI values received from the receiving block; and
transmitting the transmission-failed packets to the receiving block.

9. A method for retransmitting packets in an MIMO system, the method comprising:
if a transmitting block receives a NACK signal informing transmission failure from a receiving block, forming, for each transmission-failed packet, a set by collecting packet numbers of transmission-succeeded packets whose CQI values are equal to or greater than an initial CQI value of said each transmission-failed packet;
selecting one packet number from each set, wherein the selected packet numbers are different from each other; and
transmitting the transmission-failed packets through antennas corresponding to the selected packet numbers.

10. The method of claim 9, wherein the transmitting block selects one packet number from each set to maximize a total capacity.

11. A method for retransmitting packets in an MIMO system, the method comprising:
if a transmitting block receives a NACK signal informing transmission failure of packets from a receiving block, forming, for each transmission-failed packet, a set by collecting packet numbers of transmission-succeeded packets whose CQI values are equal to or greater than a value obtained by subtracting a threshold value from an initial CQI value of said each transmission-failed packet;
selecting one packet number from each set, wherein the selected packet numbers are different from each other; and
transmitting the transmission-failed packets through antennas corresponding to the selected packet numbers.

12. The method of claim 11, wherein the transmitting block selects one packet number from each set to maximize a total capacity.
